(19) United States
(12) Patent Application Publication
(10) Pub. No.: US 2005/0079397 A1
(43) Pub. Date: Apr. 14, 2005

(54) Metal hydride heating element

(76) Inventors: Holger Winkelmann, Mainz-Kastel (DE); Dirk Wexel, Mainz-Kastel (DE)

Correspondence Address: HARNESS, DICKEY & PIERCE, P.L.C., P.O. BOX 828, BLOOMFIELD HILLS, MI, 48303, US

(21) Appl. No.: 10/681,765

(22) Filed: Oct. 8, 2003

(51) Int. Cl. H01M 8/04; H01M 8/06

(52) U.S. Cl. 429/26; 429/20; 429/38; 429/13

(57) ABSTRACT

A heating element for a fuel cell system comprising a body constructed of a thermally conductive material. The interior of the body has a plurality of fluid flow channels formed therein. A hydrogen absorption material capable of absorbing hydrogen in an exothermic reaction to form a metal hydride in a reversible reaction is disposed within the channels. A conduit provides fluid communication to and from the channels and the exterior of the body which is in the form of a storage vessel. Hydrogen is supplied via the conduit to the flow channels and is absorbed by the hydrogen absorption material which generates heat that is transferred through the thermally conductive material to regions surrounding the storage vessel. Methods of heating a fuel cell with a device storing material capable of an exothermic reaction that generates heat are also provided.

### FIELD OF THE INVENTION

The present invention relates to electrochemical fuel cells, and more particularly to devices for heating electrochemical fuel cell systems and methods therefor.

### BACKGROUND OF THE INVENTION

Fuel cells have been proposed as a power source for electric vehicles and other applications. One known fuel cell is the PEM (i.e., Proton Exchange Membrane) fuel cell that includes a so-called “membrane-electrode-assembly” (MEA) comprising a thin, solid polymer membrane-electrolyte having an anode on one face of the membrane-electrolyte and a cathode on the opposite face of the membrane-electrolyte. The anode and cathode typically comprise finely divided carbon particles, having very finely divided catalytic particles supported on the internal and external surfaces of the carbon particles, and proton conductive material intermingled with the catalytic and carbon particles. The MEA is sandwiched between a pair of electrically conductive contact elements which serve as current collectors for the anode and cathode, and may contain appropriate channels and openings therein for distributing the fuel cell's gaseous reactants (i.e., H₂ & O₂/air) over the surfaces of the respective anode and cathode.

A fuel cell stack comprises a plurality of individual cells bundled together into a high voltage pack. It is desirable for many applications, and particularly electric vehicle applications, that the fuel cell stack is capable of being started-up quickly so as to be immediately available to produce the energy needed to propel the vehicle without significant delay. At relatively high ambient temperatures the fuel cell stack can be started-up in a reasonable amount of time, because electrical current can be immediately drawn from the stack which, in turn, causes electrical IR-heating of the stack to quickly heat up the stack to its preferred operating temperature. At relatively low temperatures, however, rapid start-up is much more difficult, because at low temperatures the electrochemical reaction rate occurring at the MEA is significantly reduced.

There remains the challenge to create a system to facilitate a rapid start-up while optimizing fuel cell performance as cost-effectively as possible.

### SUMMARY OF THE INVENTION

In one aspect the invention provides a fuel cell system which comprises a heating element comprising a body of thermally conductive material having at least one cavity or channel. The body having one or more channels is also referred to as a vessel. A hydrogen storage medium is disposed within the channel or channels. The hydrogen storage medium is capable of absorbing and releasing hydrogen in a reversible reaction. A component of the fuel cell system is in heat transfer relationship with the body and such component and body are arranged so that hydrogen supplied to the channel or channels is absorbed by the hydrogen storage medium in an exothermic reaction generating heat which is transferred through the body and to the other fuel cell component. In one aspect, the body of thermally conductive material provides a storage vessel which comprises one or more channels. In another aspect, heat is transferred to more than one component in a fuel cell system.

In a preferred aspect, a plurality of channels is provided within the body and the body has an opening which provides access to the channels and a filter is within the opening to retain hydrogen storage medium which is in a preferred particle form. The component or components to which heat generated in the vessel is transferred can be one or more of the following: terminal collector; fluid distribution element, sometimes also referred to as bipolar plate; vessel positioned between fuel distribution elements; vessel positioned between a terminal fuel cell and a terminal collector plate; the vessel may be disposed between the terminal collector plate and the end base plate of the stack. Alternatively the heating element vessel may surround at least a portion of the stack.

Preferably the body of the storage vessel is constructed of a material which is electrically and thermally conductive. It may be formed of a number of materials including polymeric composite, metal and metal alloys. The hydrogen storage medium is preferably selected to have an equilibrium pressure for absorption of hydrogen whereby at preferably less than about five atmospheres at about 25° celsius, the hydrogen storage medium absorbs hydrogen. The material then releases hydrogen in a range of operating conditions corresponding to the conditions of fuel cell operation. Thus, at temperatures below about 60° C. and pressure below about 30 atmospheres absolute, the medium reversibly forms a metal hydride and releases heat.

In one preferred aspect, the hydrogen storage medium has a hydrated state comprising metal hydride and a dehydrated state comprising metal or metal alloy. A metal or metal alloy absorbs hydrogen in an exothermic reaction generating heat. The metal hydride releases hydrogen in an endothermic reaction and requires heat be supplied from an adjacent environment.

Preferred hydrogen storage medium includes: LaNi₅, LaNi_{4.7}Al_{0.39}, TiFe_{0.9}Mn_{0.1}, MmNi_{4.5}Al_{0.5}, MmNi_{4.5}Mn_{0.5}, Ca_{0.7}Mm_{0.3}Ni₅, TiMn_{1.5}, ZrFe1.5Cr_{0.5}, Ti_{0.98} Zr₂ Vo₄₃Fe_{0.09}Cr_{0.05}Mn_{1.5}, TiV_{0.62}Mn_{1.5} and LaMm(NiSn)₅ and TiFe.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of two cells in a liquid-cooled PEM fuel cell stack;

FIG. 2 is a pressure-concentration-temperature (PCT) diagram for a hydrogen absorption material according to the present invention (LaNi₅);

FIG. 3 is a schematic illustration of one preferred embodiment according to the present invention showing a single heater plate element configuration;

FIG. 4 is a schematic illustration of an alternate preferred embodiment according to the present invention showing multiple heater plate elements within a single fuel cell stack; configuration;

FIG. 5 is a schematic illustration of an alternate preferred embodiment according to the present invention showing a configuration of multiple stacks each having at least one heater element;

FIG. 6 is partial cut away view of a terminal collector end plate according to a preferred embodiment of the present invention having a heater element incorporated therein and a side cover shown in an unassembled position;

FIG. 7 is a cross-sectional view taken along line 7-7 of FIG. 6, showing a terminal collector end plate interior incorporating a heater element according to the present invention;

FIG. 8 is a schematic illustration of two cells in a liquid-cooled PEM fuel cell stack incorporating a preferred embodiment of the present invention where two independent heater plates are disposed in the fuel cell stack between an end base plate and a terminal collector plate;

FIG. 9 is a schematic illustration of two cells in a liquid-cooled PEM fuel cell stack incorporating another preferred embodiment of the present invention where two independent heater plates are disposed in the fuel cell stack between a terminal collector plate and a terminal fluid distribution element;

FIG. 10 is a partial cut away view of an independent heater plate element according to a preferred embodiment of the present invention;

FIG. 11 is a cross-sectional view taken along the line 11-11 of FIG. 10;

FIG. 12 is a schematic illustration of two cells in a liquid-cooled PEM fuel cell stack incorporating an alternate preferred embodiment of the present invention where a fluid distribution bipolar plate assembly comprises a heater plate incorporated therein; and

FIG. 13 is a partial cross-sectional view taken along line 13-13 of FIG. 12.

### DETAILED DESCRIPTION OF THE PREFERRED EMBODIMENTS

The following description of the preferred embodiment(s) is merely exemplary in nature and is in no way intended to limit the invention, its application, or uses.

The present invention contemplates a heating element in an electrochemical cell system that provides heat during transient operating conditions where additional heat is required, such as start-up. The present invention provides such heat via a hydrogen absorption material that undergoes a reversible chemical intercalation reaction. In preferred embodiments of the present invention, the hydrogen absorption material is contained within the interior of a storage vessel constructed of thermally conductive materials. In certain preferred embodiments, the vessel is designed to serve as both a heating element and a terminal collector end plate (hereinafter “terminal plate”) in an electrochemical fuel cell stack, thus having functionality and electrical conductivity within the fuel cell stack. In other preferred embodiments, the vessel is incorporated into a fluid distribution element (e.g. a bipolar plate), where it provides heat as well as electrical conductivity between the several fuel cells of the stack. In certain alternate preferred embodiments, the heating element provides heat to the fuel cell system by an independent heater element, either by integrating the storage vessel within the stack itself or placing the storage vessel external to the stack in areas which require rapid heating. When the terminal plate or fluid distribution element is combined with the heating element, the component structure is modified to incorporate the storage vessel containing the hydrogen absorption material. Heating elements are useful for fuel cell operations, especially during start-up and transient conditions.

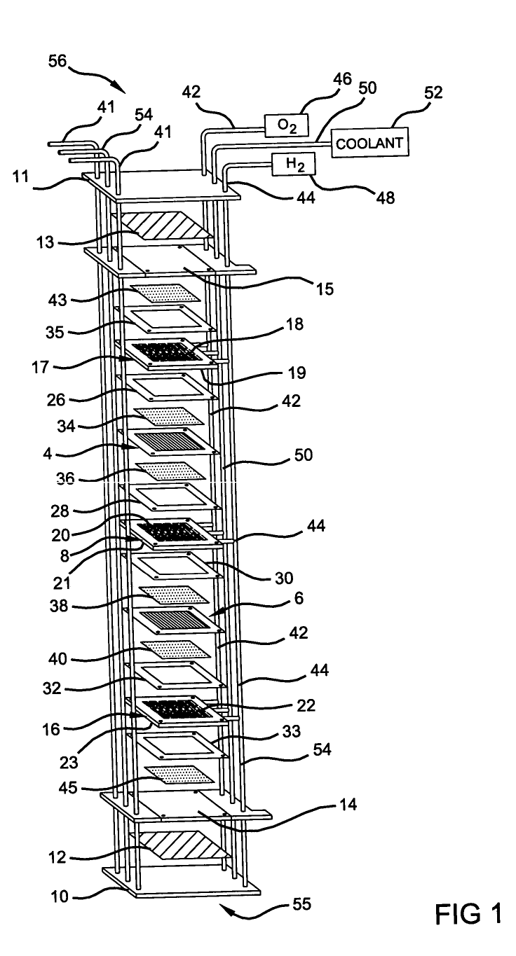

First, to better understand applications where the present invention is useful, a description of an exemplary fuel cell and stack are provided herein. An exemplary fuel cell where the present invention may be employed is shown in FIG. 1, which depicts two individual proton exchange membrane (PEM) fuel cells connected to form a stack having a pair of membrane-electrode-assemblies (MEAs) 4, 6 separated from each other by an electrically conductive, liquid-cooled, bipolar separator plate conductive element 8. An individual fuel cell, which is not connected in series within a stack, has a separator plate 8 with a single electrically active side. In a stack, a preferred bipolar separator plate 8 typically has two electrically active sides 20, 21 within the stack, each active side 20, 21 respectively facing a separate MEA 4, 6 with opposite charges that are separated, hence the so-called “bipolar” plate. As described herein, the fuel cell stack is described as having conductive fluid distribution elements including bipolar plates, however the present invention is equally applicable to fluid distribution elements that are next to a single fuel cell.

The MEAs 4,6 and bipolar plate 8 are stacked together between stainless steel end clamping base plates 10,11, thermal and electrical insulation sheets 12, 13, terminal collector elements 14,15, and end contact fluid distribution elements 16,17. The end fluid distribution elements 16,17, as well as both working faces or sides 20,21 of the bipolar plate 8, contain a plurality of lands adjacent to grooves or channels on the active faces 18, 19, 20, 21, 22, and 23 for distributing fuel and oxidant gases (i.e., H₂ and O₂) to the MEAs 4,6. Nonconductive gaskets or seals 26, 28, 30, 32, 33, and 35 provide seals and electrical insulation between the several components of the fuel cell stack. Gas-permeable conductive diffusion media 34, 36, 38, and 40 press up against the electrode faces of the MEAs 4,6. Additional layers of conductive media 43, 45 are placed between the end contact fluid distribution elements 16,17 and the terminal collector plates 14,15 to provide a conductive pathway therebetween when the stack is compressed during normal operating conditions. The end contact fluid distribution elements 16,17 press up against the diffusion media 34,43 and 40,45 respectively.

Oxygen is supplied to the cathode side of the fuel cell stack from storage tank 46 via appropriate supply plumbing 42, while hydrogen is supplied to the anode side of the fuel cell from storage tank 48, via appropriate supply plumbing 44. Alternatively, air may be supplied to the cathode side from the ambient, and hydrogen to the anode from a methanol or gasoline reformer, or the like. Exhaust plumbing 41 for both the H₂ and O₂/air sides of the MEAs is also provided. Additional plumbing 50 is provided for circulating coolant from a storage area 52 through the bipolar plate 8 and end plates 16,17 and out the exit plumbing 54.

Start-up conditions within the fuel cell system generally pose challenges in the implementation of fuel cell technology. Such challenges are often due to low temperatures, as well as low stoichiometry of reactants during low load conditions, which results in significantly lower heat release that slows the fuel cell from equilibrating at normal operating temperatures. It is desirable for many fuel cell applications, that the fuel cell can be started-up quickly so as to be immediately available to produce the energy needed to propel the vehicle without significant delay. As used herein, “start-up” conditions generally refer to transient operating conditions when the fuel cell is transitioning or being engaged from a cold state to normal, or steady-state, ranges for operating temperature, fuel delivery and electrical output. “Normal”, “steady-state”, “non-start-up” or “run mode” conditions refer to the operating conditions when temperatures are within typical operating ranges. In current PEM fuel cell applications, such a steady-state temperature is about 70° C. to about 90° C. at typical operating pressures of between 1 to 2.8 atm absolute. Start-up temperatures are generally below 60° C. at pressures generally less than 1 atm absolute. The term start-up may further include transient operating conditions that may be the result of varying load requirements on the system, but not relating to cold start-up conditions where the fuel cell has not been operated for long periods of time.

At higher ambient temperatures (e.g. about 20° C. or greater), the fuel cell stack (i.e. plurality of individual fuel cells bundled together into a high voltage pack) can be started-up in a reasonable amount of time because electrical current can be rapidly drawn from the stack which, in turn, causes electrical IR-heating of the stack to quickly heat up the stack to its preferred operating temperature with present membranes (i.e. about 80° C. for a Nafion membrane in a MEA). The overall temperature of the stack containing fuel cells is proportional to the reactions occurring within each fuel cell, thus stack temperature increases as temperature rises. One of the primary issues during colder start-up temperatures (i.e. less than 25° C., and especially below 0° C.) is that the operational inefficiency is low due to low reaction rate, and as a result, there tends to be large discrepancies in voltage across the fuel cell stack, which may cause operational instability. The most efficient operation of the fuel cell stack occurs where there is an even distribution of current generated in each individual fuel cell 4,6 and likewise an even voltage drop across each cell of the stack. Further, the terminal ends of a stack 55,56 typically take more time to reach steady-state operating conditions (e.g. temperatures) because the terminal fuel cells (as shown in FIG. 1 there are only two fuel cells with MEAs 4,6, however in reality stacks may contain hundreds of fuel cells) are bound on one side by a terminal plate 14,15 (rather than another fuel cell generating heat). Thus, the lagging terminal end fuel cells contribute to destabilization of the stack operations.

Start-up is particularly difficult when temperatures in the fuel cell are below about 0° C. At such subfreezing temperatures, rapid start-up is much more difficult, because the rate at which the overall electrochemical reaction occurring at the membrane-electrode-assembly takes place is significantly reduced thereby limiting the amount of current that can be drawn from the stack, and hence the IR-heating that can be input to the stack. The precise mechanism for the reaction rate reduction is not known. However, it is believed to be that either (1) the H⁺ ion conductivity of the solid polymer membrane electrolyte (PEM) is particularly poor at these temperatures, or (2) the effectiveness of the catalysts to electrochemically ionize the H₂ and/or O₂ is so poor at these temperatures, that the rate of reaction is negligible and no significant amount of electrical current can be drawn from the stack, and no corresponding IR-heating thereof can occur.

Further, most fuel cell systems employ coolant that circulates through the stack to remove heat during steady-state operations. However, the coolant system (e.g. 52, 50, 54 of FIG. 1) is a significant heat sink, since most preferred coolants are chosen due to their high heat capacity values. Thus, the low temperature coolant must also be heated, and possibly thawed from a frozen state, to its steady-state temperature which is preferably between about 40° C. to about 80° C. for coolant. Hence, heat generated within the fuel cell by electrochemical reactions is typically diverted to heating the coolant or surrounding bulky metal materials. Typical fuel cell systems that heat the cell to the steady-state operating temperatures by relying upon the excess heat generated during electrochemical reactions will encounter significant time delays, as well as operational issues, if the fuel cell system is exposed to ambient temperatures below 25° C., and especially below freezing temperatures of less than 0° C.

To overcome these issues during start-up, previous methods of pre-heating the fuel cell system included, for example, an independent combustion or electrical heater, as known to one of skill in the art. Heat from a hydrocarbon reformation system may also be used to provide heat for start-up to the system. These heating systems may be used to heat the stack directly, or may provide heat to the coolant in the coolant system, which it enters the fuel cell and exchanges heat therein via a coolant circulation loop. An independent heating system requires separate fuel delivery systems or electrical conduits, and increases the burden on the system, including potential power loss, high cost, and maintenance issues. The present invention provides an integrated heating system for a fuel cell system that employs existing fuel cell reactant delivery systems to generate controlled heating in a self-regulating manner.

According to preferred embodiments of the present invention, the heater system operates by employing a hydrogen absorption material to generate required heat. The hydrogen absorption material preferably comprises a metal alloy that forms a metal hydride by absorbing hydrogen. During the uptake reaction with hydrogen, heat is released exothermically. In preferred embodiments of the present invention, the absorption or intercalation of hydrogen into the metal alloy is a substantially reversible reaction. By “substantially reversible” it is meant that the during the desorption reverse reaction (i.e. release of hydrogen), the material releases about 80% or greater of the hydrogen that was absorbed in the absorption reaction or forward reaction. This reversible process is known as hydriding. An example of a hydriding process is shown in

$$Equation ( 1 ) \text{:} \\ M ( s ) + \frac{1}{2} {H}_{2} ( g ) ⟷ MH ( s ) \qquad ( 1 )$$

where M(s) is the solid phase hydrogen absorption metal alloy, MH(s) is the solid phase metal hydride, and hydrogen (H₂(g)) is provided in gaseous form. Equation (1) is a solid-gas reaction process where hydrogen is absorbed during an exothermic charge reaction and is released during an endothermic discharge reaction. The stoichiometry is dependant on the composition of M and the overall charge of M, thus MH_{y} is more general where y is selected to provide charge balance.

Many different alloys are capable of such a hydriding process. Preferred aspects of the present invention include a hydrogen absorption compound that permits low temperature hydrogen charging (i.e. below 60° C., preferably below 25° C., and most preferred below 0° C.) into the hydrogen storage material. Further, it is preferred that the hydrogen absorption material according to the present invention has a hydrogen absorption reaction that is an exothermic process, and releases heat to the surrounding components during hydrogen charging which transforms the metal alloy to a metal hydride. In such a preferred hydrogen absorption compound, the converse also applies, in that heat is absorbed when the hydrogen is released (discharged) from the metal hydride through an endothermic reaction. It is also preferred that the discharge of the hydrogen is conducted within the range of operating temperatures and pressures of the fuel cell system, so that the surrounding environment will fall below the plateau pressure at a given operating temperature, thus permitting release of hydrogen from the hydrogen storage material. Certain preferred metal alloys that undergo hydrogen absorption to form metal hydrides at preferred temperature and pressure conditions, according to the present invention, are known as “low-temperature hydrides” in the art.

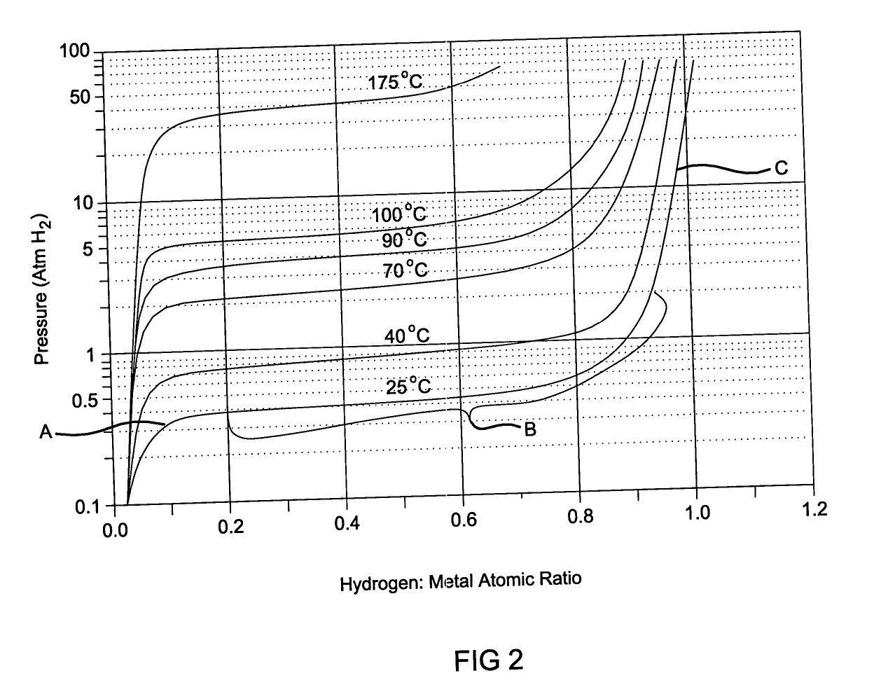

FIG. 2 shows a pressure-concentration-temperature (PCT) diagram for one preferred low temperature metal hydride hydrogen absorption material, LaNi_{4.7}Al_{0.3}. As shown in FIG. 2, equilibrium pressure for absorption of hydrogen over the range of concentrations of hydrogen in the metal alloy (expressed as the atomic ratio of hydrogen to metal) are shown at various constant temperature intervals (i.e. isotherms). At a given constant temperature, or isotherm, (for example at 25° C.), the concentration of hydrogen in the metal alloy increases (point A) with increasing hydrogen gas pressure until a relatively constant value equilibrium pressure, called “plateau pressure”, is reached. Through that range, indicated by B, the hydrogen in the material condenses into a highly concentrated solid phase by reacting with the metal alloy and forming the hydride. The pressure of hydrogen in the gas phase remains constant until the hydride phase occupies the whole volume of the hydrogen absorption material. Once the full capacity of the particular metal alloy is reached, hydrogen pressure in the gas increases again (point C). When filled to capacity, the LaNi_{4.7}Al_{0.3} holds one hydrogen atom for each metal atom and becomes LaNi_{4.7}Al_{0.3}H₆ when fully hydrided. To reverse the process and release hydrogen from the metal alloy, the ambient gas pressure of the hydrogen in the environment within the fuel cell surrounding the hydrogen absorption material is decreased below the plateau pressure or the temperature of the material is raised such that it reaches a temperature where the external pressure is lower than the plateau pressure (point B).

Many of the low temperature metal hydrides, such as for example, lanthanium pentanickel (LaNi₅) are particularly suitable to heating a fuel cell system during start-up. Thus, if the hydrogen absorption and system temperature is below 25° C., for example, the pressure of the hydrogen gas in the vicinity of the hydrogen absorption material (i.e. LaNi₅) must be greater than 1.8 atm at 25° C. to achieve a hydrogen to metal atomic ratio of 0.9 (the upper limit of the plateau pressure). The higher external hydrogen pressure favors an absorption reaction of the hydrogen into the hydrogen absorption material, which in turn releases heat. The hydrogen system is preferably the same system that provides hydrogen gas to the fuel cells, however, it may also be provided by an independent storage or supply vessel. In a typical fuel cell system, the hydrogen gas delivered to the fuel cell during start-up is at a minimum pressure of 8 atm. Thus, the hydrogen inlet pressure exceeds the plateau pressure at relatively low start-up temperatures of below 25° C. In certain preferred embodiments, the heating elements of a system may be operated in an independent gas circulation system that creates the requisite pressure within the heater element by configuration and regulation of conduits and valves. It is conceivable to supply hydrogen at pressures that exceed 30 atm gauge at 25° C., and thus the hydrogen absorption material employed in preferred embodiments of the present invention may be less than or equal to about 30 atm at 25° C. The larger the differential pressure between the equilibrium pressure of the hydrogen absorption material and the hydrogen supply, the greater the driving force for the absorption of hydrogen. Thus, generally, maximizing the differential pressure is preferred to decrease the time for hydrogen absorption.

When the hydrogen absorption material is recharged (i.e., regenerated by purging of hydrogen), according to the present invention, the hydrogen partial pressure in the surrounding environment must be lower than the plateau pressure value at the steady-state operating temperatures. In the case of LaNi₅, when the surrounding temperature and the absorption material approaches 65° C., the external pressure should be below approximately 7 to 8 atm to favor hydrogen desorption. A typical fuel cell system operates between 1 to 2.8 atm absolute and the partial pressure of hydrogen is generally below the equilibrium pressure favoring hydrogen release from the metal hydride form of the hydrogen absorption material. Thus, preferred hydrogen absorption materials can have a high equilibrium pressure at steady-state operating pressures and temperatures, because the object is to have the system operating pressure fall below the equilibrium pressure, regardless of how high it is. The greater the differential pressure between the system operating pressure and the equilibrium pressure, the greater is the driving force to release the hydrogen. The PCT characteristics of the hydrogen absorption material are preferred to charge and discharge hydrogen within the normal operating conditions of temperature and pressure of the fuel cell system. One preferred aspect of the present invention is that the heater may operate without need for additional pressurization or conditioning systems, and can operate effectively in existing fuel cell operating conditions, most particularly in providing heat during cold-start operating conditions.

Another preferred aspect of preferred embodiments of the present invention include a self-regulating heating system due to the thermodynamics and rate of reaction of the hydrogen absorption material, which is responsive to the rate of heating of the surroundings. For example, in the case of a cold start in temperatures below 0° C., when hydrogen is introduced to the hydrogen absorption material it is absorbed and releases heat. Such heat rapidly transfers to the adjacent relatively cold surrounding environment and components via thermally conductive material, thus the absorption material itself remains relatively cold. As heat is transferred to the surrounding areas, the temperature of the absorption material itself also rises in proportion to the rate of temperature change, which increases the plateau pressure as the temperature increases. The larger the differential pressure between the actual hydrogen gas pressure and the plateau pressure, the larger a driving force for reaction within the hydrogen absorption material. Thus, as the temperature of the material gradually increases, the differential pressure will decrease, thus diminishing the driving force for the reaction. As the rate of hydrogen uptake (reaction in the material) slows, the heat release likewise diminishes, and will eventually equilibrate, such that the hydrogen absorption material temperature is equal to the temperature of the surrounding environment within the fuel cell. This assumes that electrochemical reactions are not occurring within the cell. In the case of LaNi₅, such an equilibration temperature is about 65° C. In reality, the surroundings may be generating heat in the electrochemical reactions that will exceed the temperature of the hydrogen absorption material. Thus, the rate of heat release from the hydrogen absorption material is proportional to the rate of heat demand within the system.

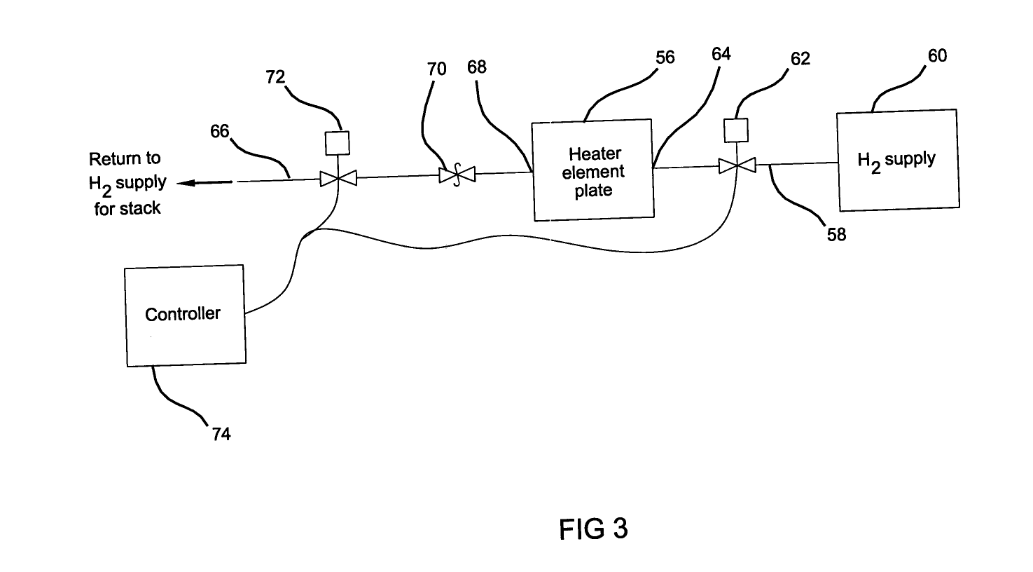

FIG. 3 shows a schematic representation of a single heater element configuration according to the present invention, which provides a simplified method of controlling a heater element 56 for the fuel cell system by an independent gas circulation system. A heater element 56 is in fluid communication with a hydrogen supply conduit 58. The supply conduit 58 is connected to a hydrogen supply tank 60 or source (preferably the same source that provides hydrogen to the fuel cells within the stack, 48 of FIG. 1). An inlet actuated control valve 62 is placed before an inlet 64 to the heater element 56. An outlet conduit 66 is also provided which is in fluid communication with an outlet 68 of the heater plate element 56. A pressure relief valve 70 is situated within the outlet conduit 66, near the outlet 68 of the heater element 56. An outlet actuated control valve 72 is disposed in the outlet conduit 66 after the pressure relief valve 70. In preferred embodiments, the outlet conduit 66 connects to the hydrogen supply leading to the fuel cells within the stack (e.g. 44 of FIG. 1).

The actuated inlet and outlet control valves 62,72 are connected to a controller 74. In preferred embodiments, the controller 74 actuates the control valves 62,72 based on a predetermined time interval. The time interval can be calculated for the heat necessary for start-up conditions based on the characteristics of the hydrogen absorption material selected for the heater element 56. Thus, upon starting the fuel cell, the inlet valve 62 will be opened to permit ingress of hydrogen gas to the heater plate element 56. The closed outlet valve 72 permits a build-up of pressure within the heater element 56, facilitating a pressure well above the equilibrium pressure of the hydrogen absorption material, hence favoring absorption of the hydrogen into the metal alloy. After the start-up sequence is completed and the predetermined time passes, the inlet valve 62 will close stopping hydrogen gas from entering the heater plate element 56, while the outlet valve 72 will open. Although the predetermined time parameter for the control system is preferred for its relative simplicity, in alternate embodiments, any system parameter or combination of parameters may be used to control the actuated valves 62,72 such as temperature, for example.

The pressure relief valve 70 is set at a relief pressure that corresponds to a pressure slightly less than the equilibrium pressure (e.g. the equilibrium pressure corresponding to temperatures of between about 60° C. to about 70° C. or the lower range of steady-state operating temperatures). Thus, once the heater element 56 reaches a steady-state temperature, the pressure exceeds the pressure relief valve 70 set point, and the hydrogen gas exits from the heating element 56 through the outlet conduit 66 through the pressure relief valve 70 and past the open outlet valve 72. If the system temperature is less than steady-state operating temperature, the hydrogen gas will be trapped within the heating element 56 between the pressure relief valve 70 and the closed inlet valve 62, which will favor absorption of the remaining quantity of trapped hydrogen due to the pressure build-up. Hydrogen absorption continues while there remains a sufficient supply of hydrogen and additional metal hydride capacity for hydrogen uptake. After the pressure exceeds the threshold pressure, it will be released by the relief valve 70 and re-enter the hydrogen supply system to be transported into the fuel cells for electrochemical reaction. One preferred advantage of the present embodiment is that a sufficient amount of hydrogen is taken up into the heating element 56 to facilitate further heating during a range of start-up temperatures, however, the stored hydrogen is released prior to unnecessary heating of the fuel cell system. The heating element 56 operation corresponds to the fuel cell system operation, and is self-regulating, without the need for additional control systems. Further, the hydrogen absorption material is regenerated during this process, making it particularly advantageous for fuel cell systems that are used intermittently and potentially undergo frequent start-ups in cold ambient conditions (i.e. vehicular applications).

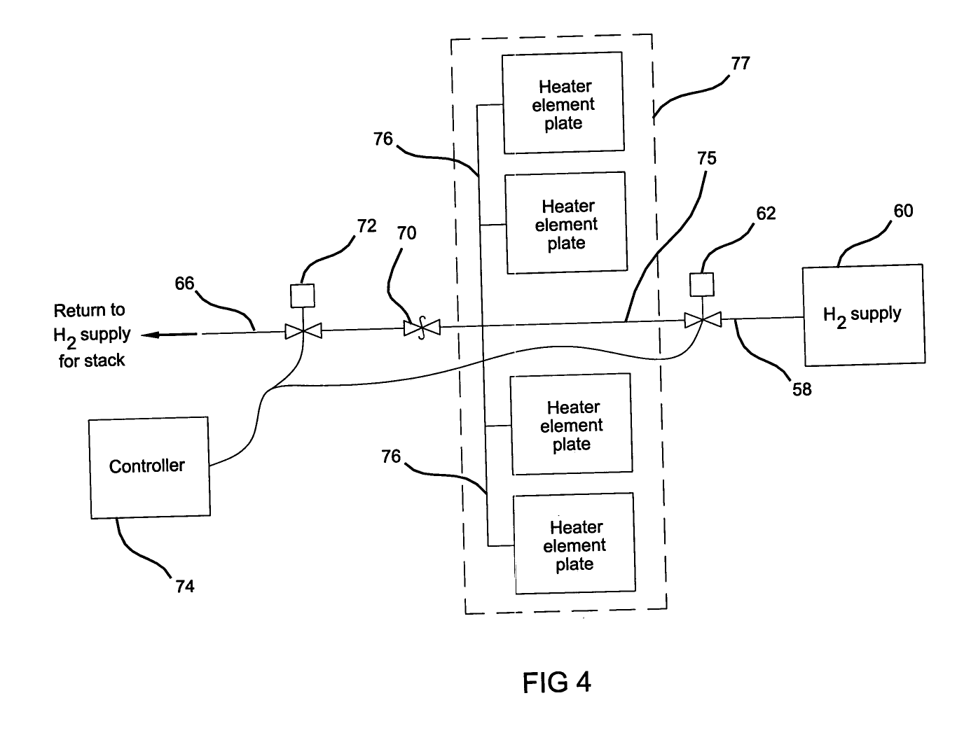

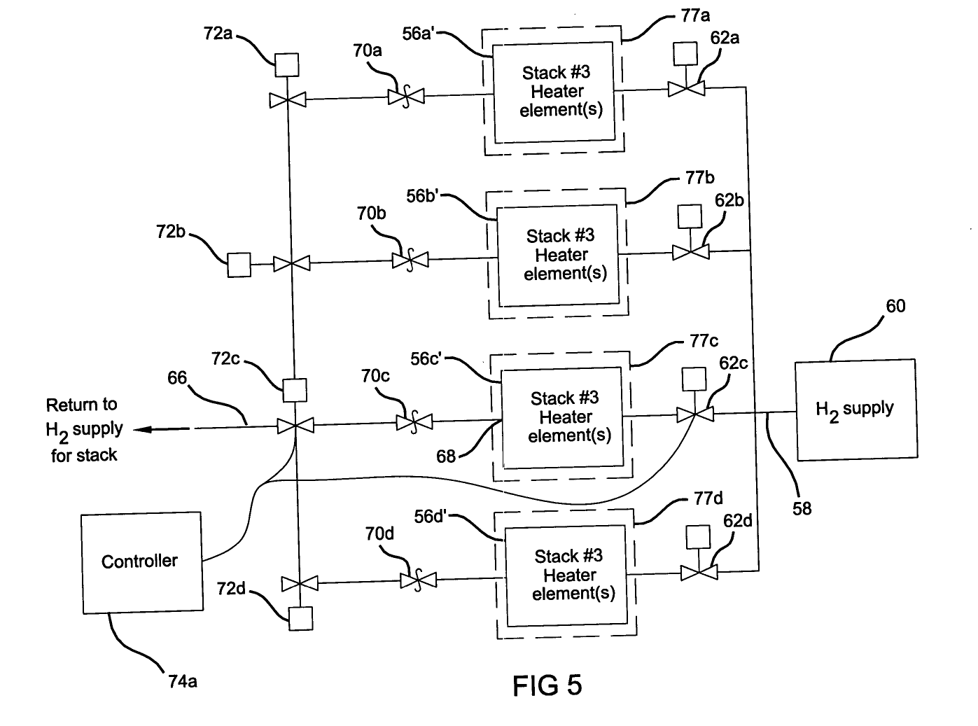

One alternate preferred embodiment is a stack having multiple heater elements configured as shown in FIG. 4. The hydrogen supply 60 enters the inlet conduit 58 through the inlet valve 62, in the same manner as a stack with a single plate 56 shown in FIG. 3. An internal conduit 75 within conduit 76 that provides fluid communication splits into a manifold stack 77 from multiple heater elements 56a, 56b, 56c, 56d within the single stack 77. The internal conduit 75 is further connected to the pressure relief valve 70 which is in line with the outlet valve 72, leading to the outlet conduit 66. In the present embodiment, multiple heater element plates 56a, 56b, 56c, and 56d, are all operated in parallel, and provide a way to start-up the single stack 77 with multiple heater plates, using the same valve configuration controller and thermal regulation as that of the previous embodiment shown in FIG. 3. It is contemplated that multiple heater elements may be required within a fuel cell system that service independent stacks. Thus, in fuel cell systems, multiple stacks may be connected to one another in series or in parallel. As described above, multiple heater plate elements may be included in a single stack, and may be adapted to the present invention. In FIG. 5, multiple fuel cell stacks 77a, 77b, 77c, 77d each contain one or more heater elements 56a′, 56b′, 56c′, and 56d′. The hydrogen storage supply 60 is connected to the inlet conduit 58 having actuated inlet valves 62, 62a, 62b, 62c, and 62d which lead to each respective heater element 56a′, 56b′, 56c′ and 56d′. Each respective heater element 56a′, 56b′, 56c′, and 56d′ are connected at the outlet to respective pressure relief valves 70a, 70b, 70c, and 70d, as well as to the outlet valves 72a, 72b, 73c, and 72d. The onlet conduit 66 provides a path for hydrogen effluent that is expelled from each of the stacks 77a, 77b, 77c, and 77d. The controller 74a provides similar valve regulation as in previous embodiments. Operation of the actuated inlet and outlet valves 62, 72 is similar to the previous embodiment described, and is preferably dictated by a timing sequence calculated for start-up. However, other system parameters may also be used to dictate the control sequences in the controller 74a (as previously discussed above). Preferred aspects of the present embodiment include a configuration enabling independent operation and regulation of flow into and out of each stack such that operation is not dedicated to a single system start-up and may facilitate independent start-up, operation, and shut down of the respective stacks 77a-d. As appreciated by one of skill in the art, the actual placement and number of valves and pipes may vary within the system configuration and achieve the same operational goals. The present configuration demonstrates one preferred method of achieving such operational goals, but other variations are contemplated by the present invention to achieve the same operational ends.

Preferred metal alloys suitable as hydrogen absorption material are thus capable of forming metal hydrides at relatively low temperatures experienced by a fuel cell and are able to desorb hydrogen at the steady-state operating temperatures of the fuel cell system. Examples of one group of preferred metal alloys according to the present invention may be expressed by the following nominal formula: AB₅ or AB₂, where A is first metal species which is preferably a rare earth metal or calcium, or titanium, and B is a second metal species which is preferably a transition metal or aluminum. Rare earth metals according to the present invention include lanthanum (La), neodynium (Nd), cerium (Ce), praseodymium (Pr) and transition metals may include: iron (Fe), tin (Sn), nickel (Ni), aluminum (Al), cobalt (Co), and manganese (Mn) and is also preferred. “A” may also be mischmetal (designated in the art as “Mm”) which is a commercially available mixture of rare earth elements, predominantly Ce, La, Nd, and Pr. Non-limiting examples of preferred AB₅ hydrogen absorption metal alloys comprise, LaNi₅ and MmNi₅. LaNi₅ is a particularly preferred hydrogen absorption metal alloy/low temperature hydride compound.

Other preferred hydrogen absorption metal alloys may include mixtures of B metal species metals, and may be expressed by the following nominal formula of B=Bₐ₍₁₋ₓ₎B_{b(x)} where Bₐ is a first transition metal; B_{b} is a second transition metal; and x<1. Examples of such AB₅ mixtures of hydrogen absorption alloys may comprise LaNi_{4.7}Al_{0.3}, TiFe_{0.9}Mn_{0.1}, MmNi_{4.5}Al_{0.5}, and MmNi_{4.5}Mn_{0.5}. Useful AB₂ hydrogen absorption metal alloys comprise ZrFe_{1.5}Cr_{0.5}, for example. Further examples of preferred hydrogen absorption alloys according to the present invention may have mixtures of the A first metal species component expressed generally by the nominal formula A=A_{a(1-y)}A_{b(y)} where Aₐ is a first metal or mixed metal in the first metal species, A_{b} is a second metal or mixed metal in the first metal species, and y<1. A non-limiting example of such an alloy may comprise Ca_{0.7}Mm_{0.3}Ni₅. Other suitable hydrogen absorption metal alloys include LaMm(NiSn)₅ or Ti_{0.98}Zr_{0.02}V_{0.43}Fe_{0.09}Cr_{0.05}Mn_{1.5}, TiV_{0.62}Mn_{1.5}, TiFe, for example. In TABLE 1 below, select hydrogen absorption metal alloy materials that are suitable with the present invention are shown, demonstrating the temperature corresponding to an equilibrium plateau pressure of 1 atm, as well as the equilibrium plateau pressure at 25° C. These materials exhibit desirable relatively low equilibrium pressure at low temperatures, which are compatible with heating elements according to the present invention.

TABLE 1

| Material | LaNi₅ | TiFe | MmNi_{4.5}Al_{0.5} | MmNi_{4.5}Mn_{0.5} | Ca_{0.7}Mm_{0.3}Ni₅ | TiFe_{0.9}Mn_{0.1} |
|---|---|---|---|---|---|---|
| Pressure | 1 | 1 | 1 | 1 | 1 | 1 |
| (atm) | | | | | | |
| Temperature | 12 | −8 | −6 | −9 | −7 | 3 |
| (° C.) | | | | | | |
| Pressure | 1.8 | 4.1 | 3.8 | 2.5 | 3.8 | 2.6 |
| (atm) | | | | | | |
| Temperature | 25 | 25 | 25 | 25 | 25 | 25 |
| (° C.) | | | | | | |

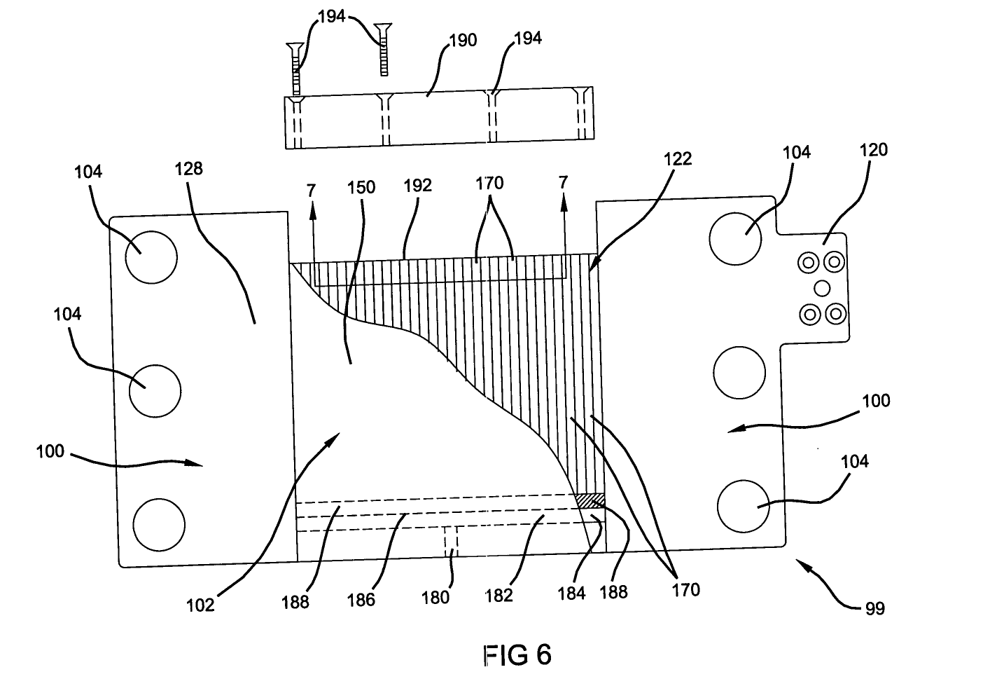

In one preferred embodiment of the present invention as shown in FIG. 6, a heating element for the fuel cell also serves as a functional component of the fuel cell stack. A terminal collector plate 99 is shown having electrically conductive regions 102 which are typically separated from electrically non-conductive regions 100 by sealing gaskets 33,35 (FIG. 1). Apertures 104 within the non-conductive region 100 extend through the body, or substrate, 128 of the terminal plate 99 and permit fluid transport (e.g. H₂, O₂, coolant, anode and cathode effluent) both into and out of the stack during operating conditions. The particular quantity or sequence of the apertures 104 is not limiting, and is merely exemplary as described herein, as numerous configurations are possible as recognized by one of skill in the art. A bipolar plate flow field design may dictate the inlet and outlet aperture 104 configurations and fluid delivery placement. An electrically conductive collector tab 120 can be attached to external leads (not shown), facilitating the external collection of current from the stack. The terminal plate 99 also has a storage vessel 122 that occupies the electrically conductive region 102.

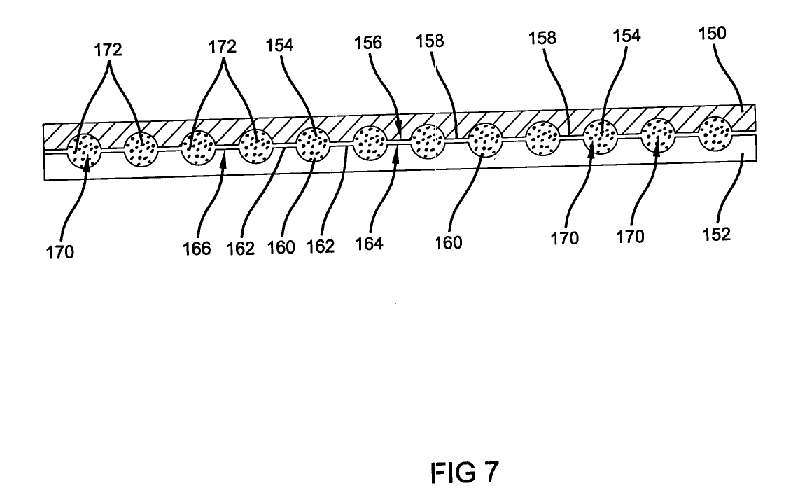

As best seen in FIG. 7, the storage vessel 122 contains an upper cover plate 150 and a lower cover plate 152. The upper cover plate 150 has a plurality of grooves 154 formed on an interior side 156, which are interspersed with lands 158. In alternate preferred embodiments, one of the cover plates may be a flat surface, and may cover the grooves formed solely in the opposite plate (not shown). In other alternate embodiments, the storage vessel 122 may be made of a solid piece of material, and may have the channels formed therein (e.g. by boring). The lower cover plate 152 also has a plurality of grooves 160 interspersed with lands 162 formed on an interior side 164. The lands 158 of the upper cover plate 150 meet with the lands 162 of the lower cover plate 152 at a plurality of contact points 166, where it is preferred that the a seal is formed preventing fluid and particulates from traveling across the lands. The grooves 154, 160 may be formed by any method known in the art, including extrusion, machining, molding, cutting, carving, stamping, photo etching such as through a photolithographic mask, or any other suitable design and manufacturing process.

Since the stack is under compressive force during fuel cell operation, the lands 158,162 generally form a strong seal without need for additional sealing. In certain alternate preferred embodiments, a conductive adhesive, diffusion welding, or brazing may be used at the contact points 166 to ensure the structural integrity of the seal, as is known in the art. Thus, when the upper and lower cover plates 150,152 are contacted with one another a plurality of channels 170 are formed. Hydrogen storage material 172 is disposed within the channels 170 in particulate form to form a porous pathway to permit fluid flow through the entire length of the channel 170. In preferred embodiments, the metal alloy particles have a pore size ranging from less than 20 μm (e.g. 15 μm) up to approximately 40 μm. For drafting simplicity, the hydrogen storage material 172 is only depicted in only a few channels 170, however preferably would be disposed in each channel 170.

With renewed reference to FIG. 6, a hydrogen conduit 180 is provided to permit fluid communication (e.g. hydrogen gas) between the storage vessel 122 and surrounding regions of the terminal collector plate 99. The conduit 180 leads to a header region 182 within the storage vessel 122 that extends from one side 184 of the storage vessel 122 to an opposite side 186. The header 182 is in fluid communication with each channel 170, and permits for ingress and egress of hydrogen gas from each channel 170. Many of the preferred hydrogen absorbing metal alloy materials transform to a powder (or a smaller particulate form) when they become metal hydrides. A filter 188 is disposed between the header 182 and the channels 170, and extends from one side 184 to the opposite side 184. The filter 188 prevents loss of the powder form of the hydrogen storage media 172 during the releasing of hydrogen gas during the regeneration step. Thus, when using these materials, it is preferred that a filter 188 has a pore size of between about 0.5 to about 20 μm and is disposed between the hydrogen conduit 180/header 182 and the hydrogen absorption material 172. Such a filter 188 may be constructed of sintered stainless steel metal, for example. Further, as recognized by one of skill in the art, the configurations of channels 170 and placement and number of the conduit 180 may vary from the configuration depicted in FIG. 6, and may include an inlet and outlet conduit for the plate, multiple conduits, multiple channels, or multiple headers and filters, which permit fluid ingress and egress from the storage vessel 122. After the upper cover plate 150 is placed over the lower cover plate 152, a side cover 190 is positioned proximate to a side end 192 of the storage vessel 122. The upper and lower cover plates 150,152 are coupled together by any known method in the art, such as welding, brazing, or gluing. The plurality of fasteners 194, as shown, fasten or attach, the side cover 190 to the storage vessel 122.

Materials of construction for the storage vessel 122 preferably are selected for resistance to attack by hydrogen (e.g. hydrogen embrittlement) as the material will have high exposure to hydrogen gas; high thermal conductivity for transferring heat to regions of the plate 99 proximate to the storage vessel 122. Other preferred characteristics include high electrical conductivity where the heating plate element is placed within the fuel cell stack and must conduct current so that it does not increase the electrical resistance of the stack, as well as impermeability to gas, low density, corrosion resistance, pattern definition, thermal and pattern stability, machinability, cost and availability. Further, where the storage vessel 122 is incorporated into a functional element, such as the terminal collector plat 99, such materials should be characterized by sufficient durability and rigidity to function in a conductive element within a fuel cell.

Preferred construction materials may comprise an electrically conductive metal, metal alloy, or composite material. Available metals and alloys include titanium, aluminum, platinum, stainless steel, nickel based alloys, and combinations thereof. Composite materials may comprise graphite, graphite foil, conductive particles (e.g. graphite powders) in a polymer matrix, carbon fiber paper and polymer laminates, polymer plates with metal cores, conductively coated polymer plates, and combinations thereof. In certain preferred embodiments the storage vessel will be constructed of materials comprising aluminum. One particularly preferred material of construction is AlMg₃, which is generally not susceptible to hydrogen attack, and further has relatively high electrical and thermal conductivity and is relatively lightweight.

Other materials of construction may include metals susceptible to hydrogen attack, such as titanium, platinum, stainless steel, or nickel based alloys, for example, which are overlaid with electrically conductive prophylactic polymer matrix coatings known in the art, which protect the underlying substrate from hydrogen attack or corrosion. The preferred conductive prophylactic polymer matrix coatings comprise a polymer matrix which include a base polymer or mixtures of polymers that are water-insoluble when cross-linked or cured, and which can form a thin adherent film to the metallic or composite substrate 128 beneath. Further, preferred polymers for a protective coating can withstand the hostile oxidative and acidic environment of the fuel cell. Hence, polymers, such as epoxies, silicones, polyamide-imides, polyether-imides, polyphenols, fluoro-elastomers (e.g., polyvinylidene fluoride), polyesters, phenoxy-phenolics, epoxide-phenolics, acrylics, and urethanes, inter alia are seen to be useful with the present invention. Cross-linked polymers are preferred for producing impermeable coatings that provide corrosion-resistant properties.

The polymer matrix additionally comprises conductive particle fillers to permit the necessary conductivity. It is preferred that the conductive prophylactic polymer matrix coating is electrically conductive, and has a resistivity less than about 50 ohm-cm. Depending on the characteristics of the polymer selected, the conductive prophylactic polymer matrix coating may optionally further comprise oxidation-resistant, acid-insoluble, electrically conductive particles (i.e., less than about 50 μm) dispersed throughout the conductive prophylactic polymer matrix coating. These conductive particles enable electrical conductivity through the conductive prophylactic polymer matrix coating. The conductive particles are selected from the group consisting of: gold, platinum, graphite, carbon, nickel, conductive metal borides, nitrides and carbides (e.g., titanium nitride, titanium carbide, titanium diboride), titanium alloys containing chromium and/or nickel, palladium, niobium, rhodium, rare earth metals, and other noble metals. Most preferably, the particles will comprise carbon or graphite (i.e., hexagonally crystallized carbon). The particles comprise varying weight percentages of the polymer matrix depending on both the conductive characteristics of the polymer itself (determining the extent of conductivity needed) and further the density and conductivity of the particles (i.e., particles having a high conductivity and low density can be used in lower weight percentages). Carbon/graphite containing conductive polymer matrix coatings will typically contain 25 percent by weight carbon/graphite particles. Examples of corrosion and oxidation resistant protective polymers containing a plurality of electrically conductive filler particles are further described in U.S. Pat. No. 6,372,376 to Fronk, et al.

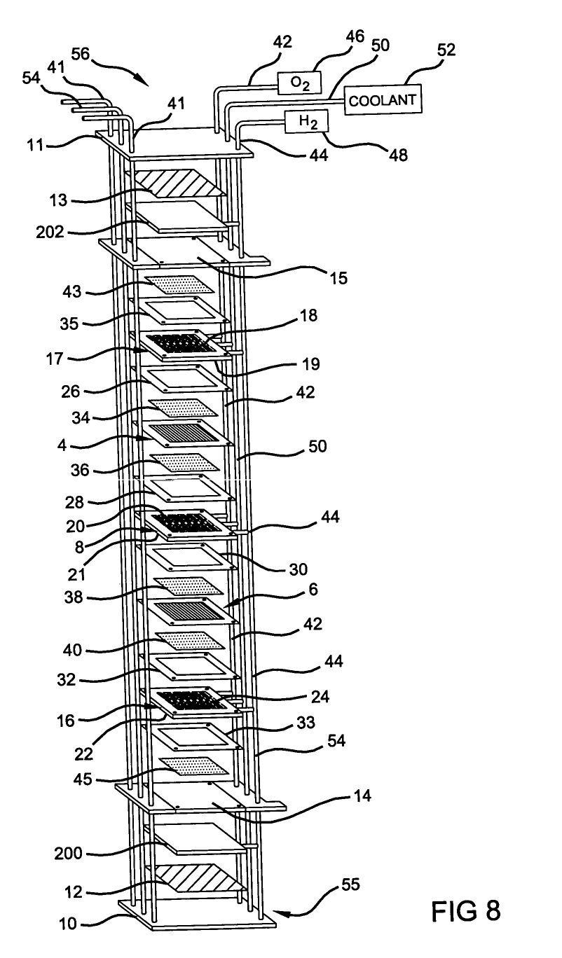

In alternate preferred embodiments according to the present invention, as shown in FIG. 8, heating elements are placed interjacent different portions of the stack to promote heating during start-up conditions, however in lieu of being combined with a functional component of the fuel cell stack, such elements are primarily employed as an independent heating element. Such a heater element may provide heat to other parts of the fuel cell system such as the coolant system, fuel reformation system and such other parts, may surround the stack, be adjacent the stack, or may be placed within the stack itself. In FIG. 8, a first heater plate 200 is disposed between the first end base plate 10 and the terminal collector plate 14 on the first side of the stack 55, and a second heater plate 202 is disposed on the opposite side 56 of the stack between the opposite end base plate 11 and the opposite terminal collector plate 15. The heater plates 200,202 are connected to the hydrogen supply conduit 44 which supplies hydrogen gas supply. Such a connection preferably includes connection to an independent hydrogen gas circulation system that draws hydrogen from the hydrogen supply conduit 44 (not shown, but as described in FIGS. 3 and 4). Further, after the hydride is formed within the heater plates 200,202 and is regenerated to reform the metal alloy as previously described, the hydrogen can be discharged into the hydrogen supply conduit 44 and fed to other fuel cells undergoing electrochemical reactions.

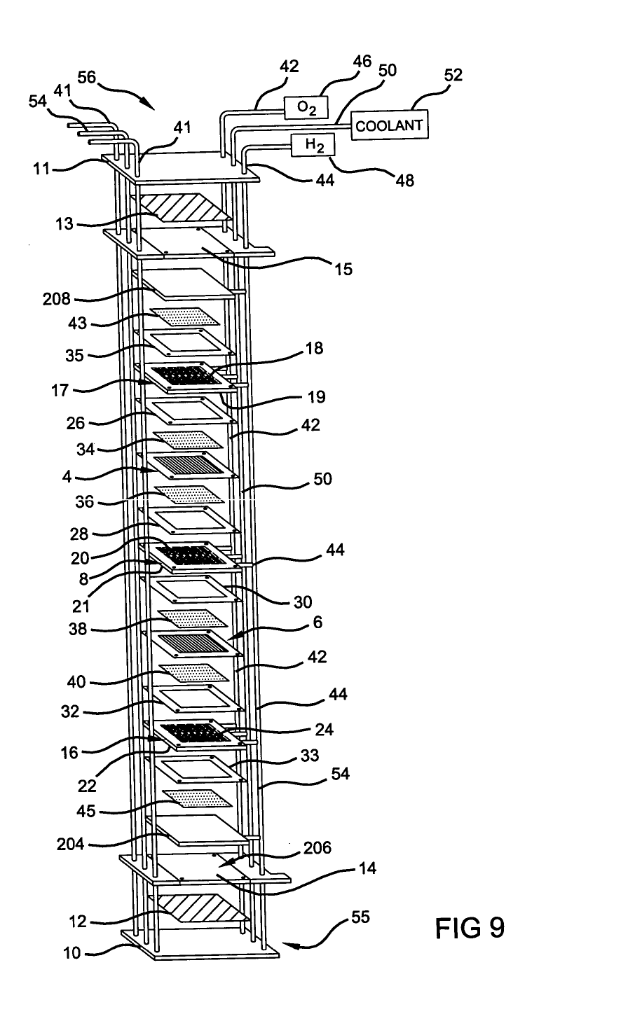

In alternate preferred embodiments, such as the one shown in FIG. 9, the independent heating elements are situated within the stack in a different location than the one shown in FIG. 8. A first heater plate 204 is disposed between an interior side 206 of the first terminal collector plate 14 and the first fluid distribution element 16 (i.e. the terminal end 55 of the fuel cell). A second heater plate 208 is likewise placed at the opposite end of the stack 56 in the same configuration, between the second terminal collector plate 15 and a second fluid distribution element 17 which provides reactants and coolant to the terminal fuel cell.

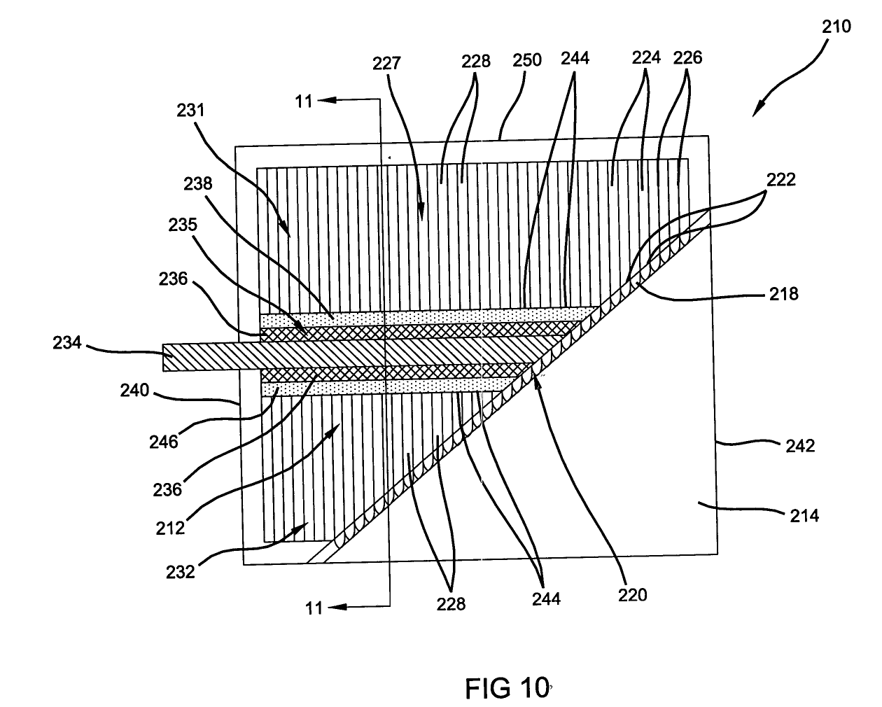

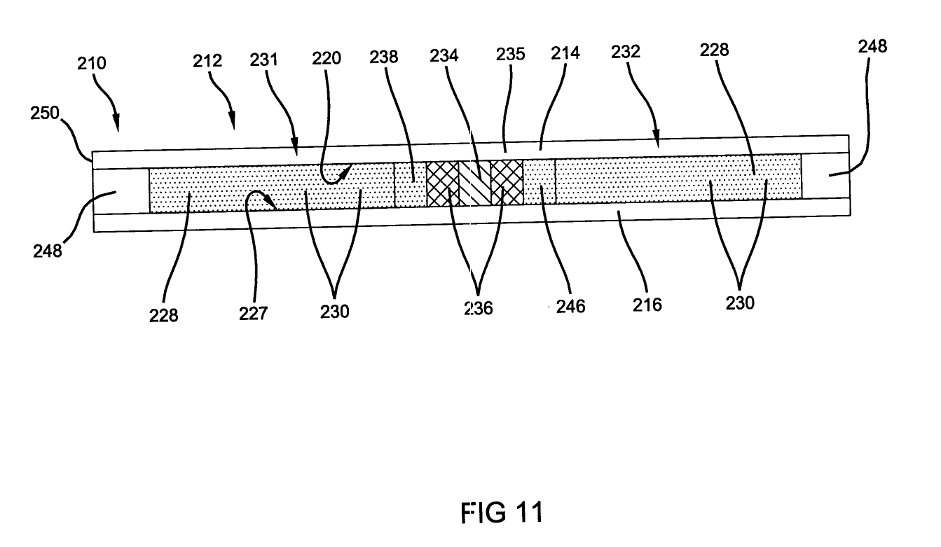

Referring generally to FIG. 10 and FIG. 11 (a cross-sectional view of FIG. 10), an example of one preferred embodiment of an independent heater plate 210 is shown. The heater plate 210 comprises a storage vessel 212 which comprises an upper cover plate 214 and a lower cover plate 216. The upper cover plate 214 has a plurality of grooves 218 formed on an interior side 220, which are interspersed with lands 222. The lower cover plate 216 also has a plurality of grooves 224 interspersed with lands 226 formed on an interior side 227. In alternate preferred embodiments, one of the cover plates (214 or 216) may be a flat surface, and may meet the lands formed in the opposite plate and thereby form channels (not shown). The lands 222 of the upper cover plate 214 meet with the lands 226 of the lower cover plate 216 at a plurality of contact points (not shown) which preferably form a seal, in the same manner as described in previous embodiments. Further, the grooves 218,224 are also formed in the same manner as previously described. Thus, when the upper and lower cover plates 214,216 are contacted with one another to form a plurality of channels 228 which contain hydrogen absorption material 230. In the present embodiment, the channels 228 are bifurcated and formed by the grooves 218 on a first half 231 of the first cover plate 214 and the grooves 224 on a second half 232 of the storage vessel 212. A hydrogen conduit 234 enters the through a center portion 235 of the storage vessel 212 and forms a hydrogen header 236 which is in fluid communication with the plurality of channels 228 on the first and second sides 231,232. A first filter 238 extends from a proximal side 240 to a distal side 242 of the storage vessel 212, and is disposed between an inlet 244 of the plurality of channels 228 on the first side 231 and the hydrogen header 236. A second filter 246 likewise extends from the proximal 240 to distal side 242 of the storage vessel 212 and is disposed between the inlet 244 of the plurality of channels 228 on the second side 232 and the hydrogen header 236. Further, the covers 214,216 may be fastened to one another by any conventional fastening means known in the art, which may include adhesives, brazing, diffusion welding, or a plurality of fasteners. A gasket or seal 148 may optionally be disposed between the covers 214, 216 to provide a fluid tight compressible seal. As appreciated by one of skill in the art, location and selection of coupling means may vary, as well as the means of providing a fluid tight seal.

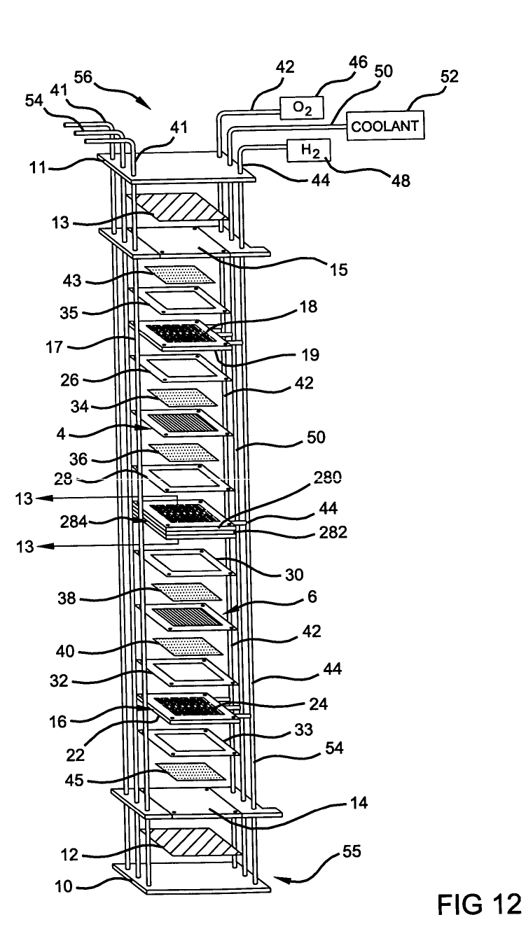

In alternate preferred embodiments of the present invention such as the one shown in FIG. 12, heater plates may be disposed in the interior portions of the stack between adjacent fuel cells. Such a heater plate assembly 280 may be integrated with the bipolar fluid distribution plate structures, such as the one shown in FIG. 1 at 8, to maintain fluid delivery of reactants to adjacent fuel cells, while containing a heating plate storage vessel 282. A modified bipolar plate assembly 280 has the storage vessel 282 incorporated into its interior region 284. As appreciated by one of skill in the art, the fuel cell may contain a plurality of fuel cells (e.g. hundreds) in a stack and the present embodiment may be employed within the corresponding plurality of bipolar plates. Most preferably the bipolar plates containing such a heater element with a storage device would be disposed at regular intervals between cells in the stack, depending on the system requirements while operating.

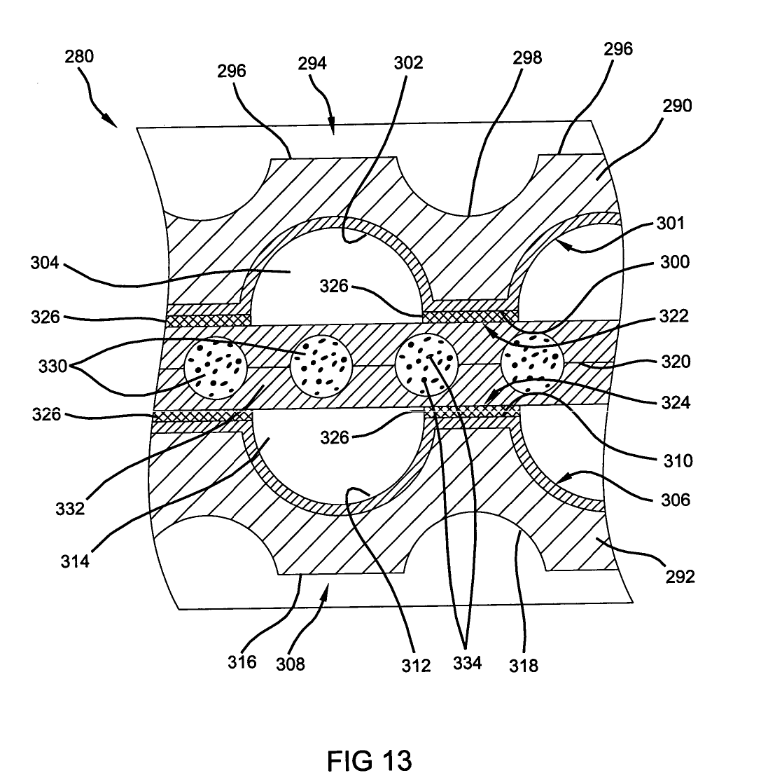

As shown best shown in FIG. 13, the modified bipolar plate 280 comprises a first sheet 290 and a second sheet 292. The first sheet 290 has a first working surface 294 on the outside thereof which confronts a membrane-electrode-assembly (not shown) and is formed so as to provide a plurality of lands 296 which define therebetween a plurality of grooves 298 creating the “flow field” through which the fuel cell's reactant gases (i.e., H₂ or O₂) flow. When the fuel cell is fully assembled, the lands 296 press against the carbon/graphite papers (such as, for example, 36 or 38 in FIG. 1) which, in turn, press against the MEAs (such as 4 or 6 in FIG. 1, respectively). The second working surface 301 of the sheet 290 includes a plurality of ridges 300 which define therebetween a plurality of grooves 302 through which coolant passes during the operation of the fuel cell. A coolant channel 304 underlies each land 296 while the reactant gas groove 298 underlies each ridge 300. Alternatively, the sheet 290 could be flat and the flow field formed in a separate sheet of material. Metal sheet 292 is similar to sheet 290. An internal surface 306 (i.e., coolant side) is opposite to a second working surface 308 of sheet 290.

Along the internal coolant side surface 306 a plurality of ridges 310 defining therebetween a plurality of grooves 312 through which coolant flows in channels 314. Like sheet 290, the external side of the sheet 292 has the working surface 308 having a plurality of lands 316 thereon defining a plurality of grooves 318 through which the reactant gases pass. A storage vessel 320 is positioned between the first sheet 290 and the second sheet 292. The storage vessel 320 has a first exterior surface 322 and a second exterior surface 324, where the ridges 300 on the first sheet 290 and the ridges 310 on the second sheet 292 are bonded (e.g. by a bonding layer 326, such as brazement or adhesives) to the storage vessel first and second exterior surfaces 322,324, respectively. The storage vessel 320 is constructed similarly to the previous embodiments electrically conductive heater elements described above, and likewise has channels 330 formed inside the vessel 320 which store the hydrogen absorption material 334. The delivery of hydrogen gas through a filter is not shown, however is configured in the same manner as previously described above. Coolant flow channels 304,314 formed between the first exterior surface 322 of the storage vessel 320 and the grooves 302 of the first sheet 290, as well as between the second exterior surface 324 of the storage vessel 320 and the grooves 312 of the second sheet 292. The coolant flowing through the channels 304,314 affords turbulence which enhances heat exchange with the exterior sheets 290,292 respectively.

As recognized by one of skill in the art, the heater elements of the present invention may vary in design from those described above, such as for example, in the configuration of flow channels, placement and number of fluid delivery manifolds, and configuration of the filtration system, however, the function of heat conductance through the surface and body of the storage vessel functions similarly between all designs.

Preferred embodiments of the present invention include methods of heating a fuel cell system in accordance with the present invention. Preferred aspects of the present invention include the self-regulatory heating of a fuel cell system from transient start-up conditions to steady-state operations. The method comprises the steps of providing a storage vessel containing a hydrogen absorption material as described above, where the material has an equilibrium pressure versus the ratio of hydrogen incorporated into the material at a given temperature (i.e. equilibrium pressure is defined across a constant temperature or isotherm). It is preferred that the material undergoes a reversible reaction absorbing hydrogen exothermically when an external pressure exceeds the equilibrium pressure at a given temperature (forming a metal hydride from a metal alloy). Such a preferred material also undergoes an endothermic reaction when the external pressure is less than the equilibrium pressure at a given temperature (regenerating a metal alloy from the metal hydride). The temperature of the material is dependent upon the temperature of the surrounding material, as well as the rate of reaction occurring as hydrogen is absorbed into the material. Hydrogen gas is introduced into the storage vessel at a pressure exceeding the equilibrium pressure of the material at a given temperature (e.g. equilibrium pressures corresponding to start-up condition temperatures of less than 60° C.). Hydrogen gas (having the pressure exceeding the equilibrium temperature) contacts and reacts with the material which generates heat. The generated heat is transferred as by conduction through the thermally conductive materials of the storage vessel or by convection through surrounding fluids to discharge heat from the storage vessel, where during start-up conditions the environment external of the vessel is at a lower temperature than the temperature of the storage vessel.

Preferred embodiments of the present invention further incorporate regeneration of the hydrogen absorption material by release of hydrogen from the material into gaseous form. This process can be accomplished when the temperature of the surrounding regions reaches or exceeds the temperature of the storage vessel. In this circumstance, the equilibrium pressure of the material exceeds the pressure of the surroundings and thermodynamically favors release of the hydrogen from the metal hydride hydrogen storage material to regenerate to the metal alloy form.

The following example describes the preparation of a independent heater element comprising a storage vessel in accordance with one preferred embodiment of the present invention.

### EXAMPLE 1

A storage vessel for a heating plate element is formed from aluminum by cold extrusion. The thickness of the whole heater plate is approximately 8 mm. The heater element storage vessel preferably occupies the same dimension as a corresponding fuel cell active area, which has a dimension of 160 mm×209 mm. The semi-circular grooves are formed in the interior of two halves of the plate and have a diameter of 4 mm and are spaced 1 mm apart from one another. The two halves are joined by brazing.

During the start-up phase the heat demand of the stack is calculated to be 500 W for 1 minute. Thus, a single heater plate element should supply a total of 30 kJ of energy. The hydrogen absorption material metal alloy used is LaNi₅, which is commercially available as either HY-Stor 205 or HYMAC 5 from Ergenics, Aldrich Chemical. The LaNi₅ has an approximate density of 5 g/cm³ and a heat of formation of −30.8 kJ/mol at 1.8 atm and 25° C. The LaNi₅ must store 0.974 mol H₂ which is equal to 1.95 g H₂ (or 21.67 liters H₂) to generate 30 kJ. For each 500 W heating element storage vessel, around 131 g of the hydrogen absorbing alloy (LaNi₅) is necessary. The hydrogen storage capacity is for LaNi₅ is around 1.49 wt % (or 3.74 g hydrogen) that will be stored in the metal hydride per plate heater. The storage volume of the heater permits 250 g of metal hydride powder to be stored. This shows that this unit could contain over 50% more alloy than what was demanded for ideal support of the 30 kJ. A hydrogen gas flowing into the structure at a rate of 0.016 mol H₂/s (or 21.52 SLPM) must be absorbed by the metal hydride to achieve an energy of 500 W. With the amount of metal hydride calculated above and with the assumption that the flow will be constant the total heating time will be 1.9 minutes. Such a unit manufactured from aluminium would weight around 345 g. With the metal hydride inside the total weight will be around 345 g+250 g=595 g per plate.

The present invention provides a method of heating a fuel cell system that facilitates and expedites start-up to reach steady-state operating conditions. Other aspects of the present invention provide further benefits in that the system is self contained and operates using existing equipment and reactants, thus not requiring additional energy consumption from the fuel cell system. Other preferred aspects of the present invention include self-regulated heat delivery that is responsive to the surrounding fuel cell system, and thus provides enhanced safety and operational efficiency. Preferred embodiments of the present invention include structures that can be incorporated into the fuel cell stack itself, both as independent heating elements or combined with functional elements, as well as heating elements that can be independently employed elsewhere within the fuel cell system.

The description of the invention is merely exemplary in nature and, thus, variations that do not depart from the gist of the invention are intended to be within the scope of the invention. Such variations are not to be regarded as a departure from the spirit and scope of the invention.

1. A fuel cell system comprising:
a heating element comprising a body of thermally-conductive material having at least one channel, a hydrogen storage medium disposed within said channel, wherein said hydrogen storage medium is capable of absorbing and releasing hydrogen in a reversible reaction; and
a component of said fuel cell system in heat transfer relationship with said body and arranged so that hydrogen supplied to said channel is absorbed by said hydrogen storage medium in an exothermic reaction generating heat which is transferred through said body to said component.

2. The fuel cell system of claim 1, wherein said at least one channel comprises a plurality of flow channels.

3. The fuel cell system of claim 2, wherein said body has an opening providing access to said flow channels and wherein a filter is disposed between said opening and said flow channels to retain said hydrogen storage medium in said flow channels.

4. The fuel cell system of claim 3, wherein said hydrogen storage medium is in particle form.

5. The fuel cell system of claim 1, wherein said at least one component comprises a terminal collector element of a fuel cell, and said terminal collector element includes said heating element.

6. The fuel cell system of claim 1, wherein said at least one component comprises an electrically conductive fluid distribution element in a fuel cell, and said fluid distribution element includes said heating element.

7. The fuel cell system of claim 1, wherein said at least one component comprises adjacent fuel cells and wherein said heating element is disposed between said adjacent fuel cells.

8. The fuel cell system of claim 1, wherein said at least one component comprises a terminal fuel cell and a terminal collector plate of a fuel cell stack, and said heating element is disposed between said terminal fuel cell and said terminal collector plate.

9. The fuel cell system of claim 1, wherein said at least one component comprises a terminal collector plate and an end base plate of a fuel cell stack, and said heating element is disposed between said terminal collector plate and said end base plate.

10. The fuel cell system of claim 1, wherein said at least one component comprises a fuel cell stack and wherein said heating element surrounds at least a portion of said stack.

11. The fuel cell system of claim 1, wherein said body is constructed of a material which is electrically and thermally conductive.

12. The fuel cell system of claim 11, wherein said material is a polymeric composite.

13. The fuel cell system of claim 11, wherein said material is a metal.

14. The fuel cell system of claim 11, wherein said material comprises a metal selected from the group consisting of: aluminum, magnesium, titanium, nickel, stainless steel, and alloys and mixtures thereof.

15. The fuel cell system of claim 11, wherein said material comprises aluminum.

16. The fuel cell system of claim 15, wherein said material comprises at least one selected from the group consisting of: Al and AlMg₃.

17. The fuel cell of claim 1, wherein said hydrogen storage medium has an equilibrium pressure for absorption of hydrogen of less than about 30 atm at 25° C.

18. The fuel cell system of claim 1, wherein said hydrogen storage medium has an equilibrium pressure for absorption of hydrogen of less than about 5 atm at 25° C.

19. The fuel cell system of claim 1, herein said hydrogen storage medium has a hydrided state comprising metal hydride and a dehydrided state comprising metal or metal alloy represented by M.

20. The fuel cell system of claim 19 wherein said metal or metal alloy, M, absorbs hydrogen according to the general equation: M(s)+H₂(g)⇄MH_{y}(s) where M is a solid phase metal alloy, hydrogen is in gaseous form, and MH is a solid phase metal hydride, and y is based on charge balance.

21. The fuel cell system of claim 19, wherein said metal alloy, M, is comprised of a composition having the nominal general formula selected from the group consisting of AB₅ and AB₂.

22. The fuel cell system of claim 21, wherein A is a first metal species selected from the group consisting of: lanthanum (La), neodynium (Nd), cerium (Ce), praseodymium (Pr), mischmetal (Mm), calcium (Ca), titanium (Ti), and mixtures thereof; and
B is a second metal species comprises a metal selected from the group consisting of: iron (Fe), tin (Sn), nickel (Ni), aluminum (Al), cobalt (Co), manganese (Mn), and mixtures thereof.

23. The heating element according to claim 22, wherein said metal alloy comprises LaNi₅.

24. The fuel cell system of claim 21, wherein B of said metal alloy is equal to the nominal general formula: Bₐ₍₁₋ₓ₎B_{b(x)}, where Bₐ is a first metal; B_{b} is a second metal; and x<1.

25. The fuel cell system of claim 20, wherein said metal alloy is selected from the group consisting of: TiFe_{0.9}Mn_{0.1}, MmNi_{4.5}Al_{0.5}, and MmNi_{4.5}Mno_{0.5}, and ZrFe_{1.5}Cr_{0.5}.

26. The fuel cell system of claim 21, wherein A of said metal alloy is equal to the nominal general formula: A_{a(1-y)}A_{b(y)} where Aₐ is a first metal or mixed metal, A_{b} is a second metal or mixed metal, and y<1.

27. The fuel cell system of claim 26, wherein said metal alloy comprises Ca_{0.7}Mm_{0.3}Ni₅.

28. The fuel cell system of claim 19, wherein said metal alloy is selected from the group consisting of: LaMm(NiSn)₅, TiMn_{0.5}, Ti_{0.98} Zr_{0.02} V_{0.43} Fe_{0.09} Cr_{0.05} Mn_{1.5}, TiV_{1.62}Mn_{1.5}, and TiFe.

29. A fuel cell system comprising:
a heating device comprising a thermally conductive body having a cavity which contains a metal alloy, wherein said metal alloy when exposed to hydrogen at temperatures below 60° C. and below 15 atm absolute reversibly forms a metal hydride and thereby releases heat; said heating device in heat transfer relationship with a component of said fuel cell system.

30. The fuel cell system of claim 29 wherein said cavity contains particles of said metal alloy.

31. A method of heating a fuel cell system comprising:
contacting gaseous hydrogen with a hydrogen absorption material comprising a metal alloy that reacts with hydrogen to form a metal hydride and thereby generate heat; and
transferring said generated heat to a component of the fuel cell system.

32. A method of heating a fuel cell system from a start-up condition, said method comprising:
providing a storage vessel containing a hydrogen absorption material having an equilibrium pressure defined by the temperature of the material and the ratio of hydrogen incorporated into said material, wherein said material undergoes a reversible reaction by absorbing hydrogen exothermically when a pressure in said vessel exceeds said equilibrium pressure at a given temperature, and by desorbing hydrogen endothermically when said pressure in said vessel is less than said equilibrium pressure at a given temperature;
introducing hydrogen gas to said storage vessel at a pressure exceeding said equilibrium pressure of said material;
generating heat by contacting said hydrogen gas with said material for absorbing hydrogen thereinto; and
transferring said generated heat to a component of said fuel cell system.

33. The method according to claim 32, further including after said transferring, releasing hydrogen from said material when a temperature of said component reaches or exceeds a temperature of the storage vessel and when said equilibrium pressure exceeds a pressure in said vessel.
